(19) United States
(12) Patent Application Publication
(10) Pub. No.: US 2017/0129087 A1
(43) Pub. Date: May 11, 2017

(54) POWER GUN FABRIC AND STAPLE REMOVAL BITS

(71) Applicants: Brant Lewis, Fort Pierce, FL (US); Janet Bruce, Vero Beach, FL (US); Richard Bruce, Vero Beach, FL (US)

(72) Inventors: Brant Lewis, Fort Pierce, FL (US); Janet Bruce, Vero Beach, FL (US); Richard Bruce, Vero Beach, FL (US)

(73) Assignee: Camberstrike LLC, Vero Beach, FL (US)

(21) Appl. No.: 15/336,224

(22) Filed: Oct. 27, 2016

Related U.S. Application Data
(60) Provisional application No. 62/246,966, filed on Oct. 27, 2015.

(51) Int. Cl. B25C 11/00

(52) U.S. Cl. CPC B25C 11/00

(57) ABSTRACT

Improved bits for removal of staples and fabric for re-upholstering, one bit having an elongated shaft, proximal end, and distal working end. The proximal end is for insertion into a power tool. The working end includes a blade wider than the shaft and a plurality of beveled teeth. The bottom section of the tool has a longitudinally cambered bottom surface curved upwardly optimizing the striking, removal action. The blade end is transversely cambered, and converging in depth. The designs create tangential application of forces as opposed to only direct linear application.

Another embodiment provides a non-symmetrical bit having a distal working end and chisel-type head that transitions into a curved side section, and an opposing straight angled side section. The bit is longitudinally cambered on the bottom surface, for separating legs of the staple without severing them, or snapping legs off from the staple crown.

### CROSS REFERENCE TO RELATED APPLICATIONS

This application claims priority from the Provisional Application Ser. No. 62/246,966, filed on Oct. 27, 2015.

### STATEMENT REGARDING FEDERALLY SPONSORED RESEARCH OR DEVELOPMENT

N/A

### BACKGROUND OF THE INVENTION

1. Field of the Invention

The present invention generally relates to removal bits and more specifically to removal bits useful for removing fabric and staples utilized for various re-upholstering tasks.

2. Description of Related Art

Staple pulling and staple removal has been tedious and time consuming for upholsterers and canvas workers since staples became commonly used in upholstery over 100 years ago. Traditionally and conventionally, workers have pulled staples entirely by manual means, assisted by a variety of hand tools that are basically close cousins of the flat screwdriver.

Recent attempts at attacking the problem of staple pulling lead to the development of specialized hand tools that are essentially screwdrivers with modified working ends that are used to pry up and otherwise damage a staple until it can be removed. These hand tools are disadvantageous for various reasons. Side effects of using such tools include but are not limited to muscle fatigue, scrapes and cuts on knuckles, hands, and fingers, and damaged fingernails. Moreover, the use of such tools results in extremely slow production times for pulling staples, with staples in small cushions for example often taking the better part of an hour to remove. Additionally, such tools can cause the legs to separate from the staples, leaving the legs embedded in the upholstery substrate, resulting in an incomplete staple removal and potentially dangerous staple parts remaining in the substrate. These parts injure fingers and hands, as well as damage and cut the fabric of the new re-upholstered work.

Other attempts at improving staple and fastener removal have been made, although most are unsuccessful at solving the problem with hand tools. For example, U.S. Pat. No. 7,232,112 to Foster describes a staple removing tool having a shaft with a working end at which opposed sloped surfaces are formed, such that the shaft, with respect to a side elevation, has a working end which substantially comes to a pointed end. A notch is formed in the forward end of the tool, and a slot extends rearwardly from the apex of the notch. The tool is rotated to remove staples from furniture and can be adapted for insertion into an electric drill or screwdriver. There is no disclosure as to how this could be adapted for a power tool.

U.S. Pat. No. 6,260,825 to Willis illustrates a staple removing tool which can be attached to a power tool such as a pneumatic hammer gun or which can be used manually. The tool includes a shaft having a handle affixed at a right angle to the shaft, and an angled tip to assist in prying.

U.S. Patent Application Publication No. 2014/0299824 to Knox discloses a staple-pulling tool configured to facilitate the removal of carpet pad staples from floors by a standing user. The staple-pulling tool has a handle section, a blade section, and a fulcrum. The handle section can be configured to have an adjustable length capable of fitting users of varying heights. The blade section can be connected to the handle section at an angle. The blade section includes a series of teeth that can accommodate the width of carpet pad staples. The fulcrum can be located beneath the handle section including wheels. The wheels assist a user to move the staple-pulling tool and can also provide leverage for the user to pull the staples. When a user pushes down on the handle, the teeth pull the carpet pad staples from the floor.

U.S. Pat. No. 4,637,538 to Wagner describes a pneumatically powered tool for removing staples from upholstered furniture and other surfaces. The tool includes a pivoted staple pulling bit which has a chisel shaped end portion sized for insertion along a surface beneath a staple. A reciprocating plunger having a cam shaped end portion is in communication with the rear portion of the bit. Forward movement of the plunger forces the cam shaped end against the bit pivoting the chisel shaped end portion upward.

Many of these devices also utilize a hexagonal shaft, designed to fit into small underpowered equipment and pneumatic hammers. A major drawback of these design is that the shank will not swivel or rotate, which drastically slows down production as well as causes hand, arm and wrist fatigue.

While these devices alleviate some of the problems associated with manual removal of staples, they are all inherently designed to either “pull” the staple out or damage and destroy the staples without regard to damage to the surrounding fabric or underlying substrate (cushioning, paneling, floor boards, etc. . . . ). Additionally, these devices generally will require the development of a high level of skill to accurately remove staples and fasteners, without injuring or leaving an otherwise inexperienced canvas worker with a very difficult and time consuming job that comes with a painful learning curve.

It is, therefore, to the effective resolution of the aforementioned problems and shortcomings of the prior art that the present invention is directed. However, in view of the staple and fastener removal bits in existence at the time of the present invention, it was not obvious to those persons of ordinary skill in the pertinent art as to how the identified needs could be fulfilled in an advantageous manner.

### SUMMARY OF THE INVENTIONS

The present inventions provide various embodiments for improved bits for removal of staples and fabric when re-upholstering cushions, furniture and the like. The instant bits have custom designed and engineered features and components, which substantially reduce the time and effort expended in the upholstering process. In one embodiment, a bit is provided with an elongated shaft having a proximal and a distal end working end. The proximal end is a shaft designed to be received in a power tool. The working end includes a blade that is wider than the shaft and includes a plurality of beveled angled teeth. The bottom section of the tool has a longitudinally cambered bottom surface that is curved upwardly in order to optimize the striking and removal action of the tool. The blade end can also be transversely cambered in width, and converging in depth towards the teeth end. The designs create tangential application of forces as opposed to just a direct linear application.

Another embodiment of the inventions provide for a non-symmetrical or asymmetrical bit having a distal working end with a chisel-type head that transitions into a curved side section on one side, and straight angled side section on the opposite side. The bit is also longitudinally cambered on the bottom surface, and has the effect of separating the legs of the staple without severing the legs or snapping legs off from the crown of the staple.

The instant shank is cylindrical and of a universal coupling, which allows the bit to rotate freely, with any angle of attack with the gun that is user friendly and comfortable. This also prevents the handle of the gun and hose from impeding the work piece.

Accordingly, it is an object of the present inventions to provide improved power gun fabric and staple removal bits which overcome the deficiencies of conventional tools and bits.

It is also an object of the present inventions to provide improved bits with enhanced engineering designs that substantially improve the time and effort expended in removing fabric and staple in the re-upholstering process.

It is also an object of the present inventions to provide improved bits with enhanced engineering designs that are cost effective and operationally efficient.

Finally, it is an object of the present inventions to provide improved bits having all of the above features and objects.

### BRIEF DESCRIPTION OF THE DRAWINGS

FIG. 1 is a top plan view of one embodiment of the present invention.

FIG. 2 is a side perspective view of one embodiment of the present invention.

FIG. 3 is a close-up top plan view of one embodiment of the present invention.

FIG. 4 is a close-up perspective view of the working end of one embodiment of the present invention.

FIG. 4A is an alternative top perspective view of one embodiment of the present invention.

FIG. 4B is an alternative bottom perspective view of one embodiment of the present invention.

FIG. 4C is an alternative side view of one embodiment of the present invention.

FIG. 5 is a top plan view of another embodiment of the present invention.

FIG. 6 is a side plan view of another embodiment of the present invention.

FIG. 7 is a close-up top perspective view of another embodiment of the present invention.

FIG. 8 is a close-up top perspective view of the working end of another embodiment of the present invention.

FIG. 8A is an alternative top perspective view of another embodiment of the present invention.

FIG. 8B is an alternative bottom perspective view of another embodiment of the present invention.

FIG. 8C is an alternative top view of another embodiment of the present invention.

FIG. 8D is an alternative expanded bottom view of another embodiment of the present invention.

FIG. 8E is an alternative top perspective view of another embodiment of the present invention.

FIG. 8F is an alternative bottom perspective view of another embodiment of the present invention.

FIG. 8G is an alternative expanded bottom view of another embodiment of the present invention.

FIG. 9 is a side plan view of another embodiment of the present invention.

FIG. 10 is a close-up perspective view of another embodiment of the present invention.

FIG. 11 is a close-up top perspective view of yet another embodiment of the present invention.

### DETAILED DESCRIPTION

The present invention provides several embodiments of a tool designed to assist with removing fabric and staples or fasteners from upholstery substrates. In some embodiments, the tool is configured as a bit that is adapted to fit a pneumatic or electric chisel gun known in the art. In other embodiments, the tool may be configured as a hand tool, although it is apparent that the tool will operate more effectively and efficiently when used in conjunction with a powered chisel gun.

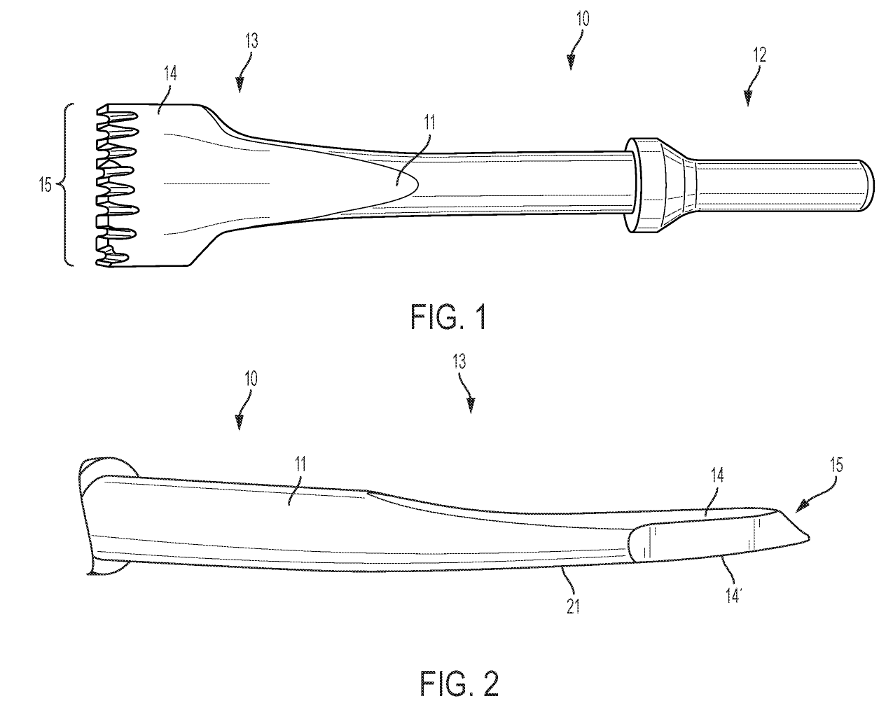

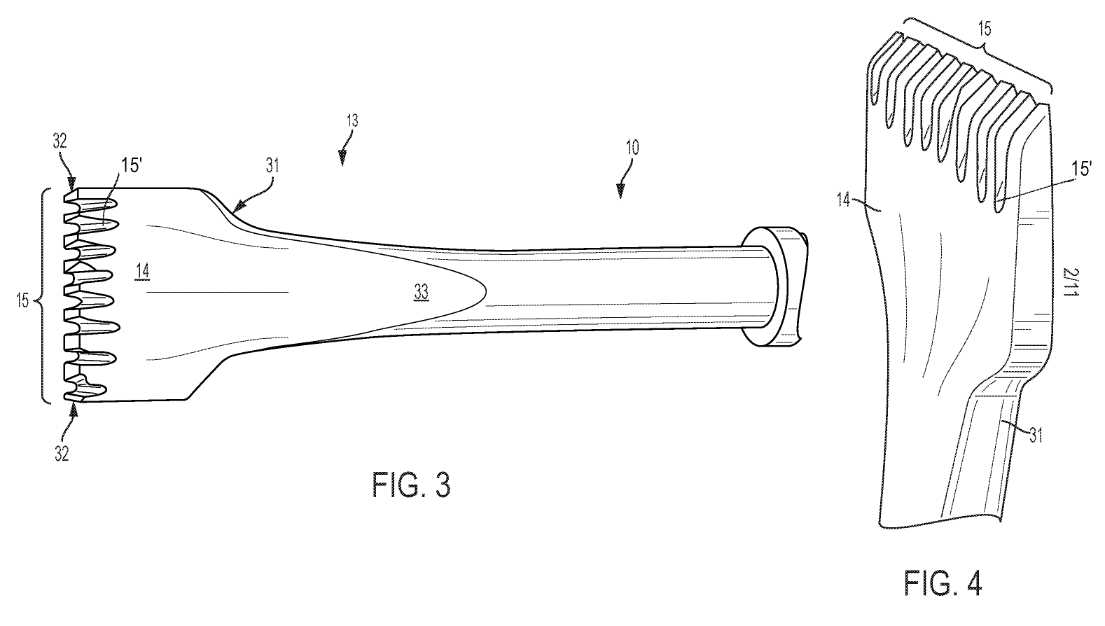

With reference to FIGS. 1-4, shown is a first embodiment of tool 10 generally comprising an elongated shaft 11 having a proximal end 12 and a distal working end 13. In some embodiments, the proximal end 12 comprises a shank adapted to be received in a chisel gun or other power tool. The distal working end 13 comprises a blade 14 that is substantially wider than the shaft from which the blade extends. In some embodiments, the blade 14 includes a plurality of teeth 15 aligned adjacent to one another along the width of the working end 13. With reference to FIG. 2, shown is a side perspective view of the tool 10. As shown, the bottom surface 21 of the tool is longitudinally cambered or curved upward in order to enhance the striking and removal action of the tool 10 when used as intended. This longitudinal cambering creates curvature on the bottom and top surfaces of the tool end section as indicated, and creates an angle between the tool 10 and the substrate during use, which creates an upward tangential application of force as opposed to a direct linear application of force.

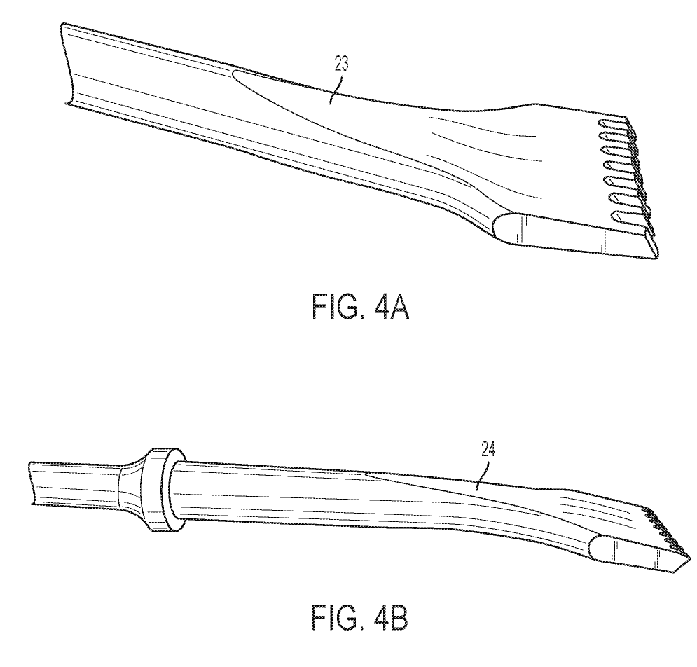

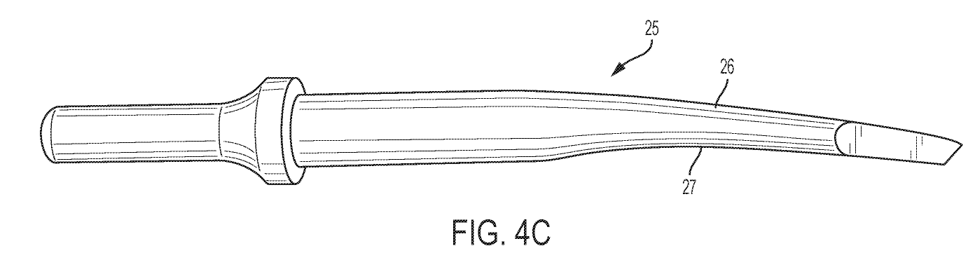

In some embodiments, the underside 14′ of the blade 14 is also transversely cambered or curved, i.e., it is curved across the width of the blade 14 from side to side. Also evident in FIG. 2 is the geometry of the teeth 15, which have a beveled leading edge angled back toward the proximal end of the tool 10. In some embodiments, this angle is approximately 45 degrees but it may vary from between 20 and 70 degrees depending on the application and size of the tool 10. With reference to FIG. 3, shown is a close up of the working end 13 of the tool 10. Here, the teeth 15 can be more readily seen. Also depicted are the angled grooves 15′ between the teeth on the blade from which the teeth protrude. Shown also is the curved or cambered transition area 31 between the blade 14 and the shaft 33 of the tool 10. Additionally, in some embodiments, the outer edges 32 of the blade 14 are radiused or cambered in order to provide smoother operation of the tool 10 as further described. FIG. 4 shows a close up of the blade 14, more closely showing the beveled angling of the teeth 15. In some embodiments, the individual teeth 15 may vary in size and, in one particular embodiment, the outer teeth are narrower in width than the central teeth in order to allow the teeth to more easily engage the fabric and staples during use.

FIG. 4A is an alternative top perspective view of the upper top cambered surface 23 of the distal working end.

FIG. 4B is an alternative bottom perspective view of the lower bottom cambered surface 24 of the distal working end.

FIG. 4C is a side view illustrating top cambered surface 27 and bottom cambered surface 26 of the distal working end.

As noted above, the tools in the present art are disadvantageous because all air hammer chisel bits or similar tools have been designed to impart a linear destructive strike to a given substrate. Existing bits will simply bend staples over and/or push them farther into the substrate. In contrast, the present tool 10 is designed to penetrate the space between the substrate and the stapled upholstery covering in order to remove the covering from the substrate along with the staples, without damaging the covering or surrounding area. Removing staples is achieved by first inserting a tool 10 into an air hammer/chisel and then aligning the blade 14 with a staple at the fabric boarder. Triggering the air hammer produces quick powerful strikes with the chisel bit against the staple and fabric boarder. The staples and fabric lift out almost instantly as they are struck. The striking end, namely blade 14, has fine teeth 15 with which to catch or otherwise “grab” the staple legs as well as allow teeth to fit under the staple crown, as well as the fabric. The tools 10, 50, and 90 are designed to use the fabric as a lever of sorts to remove the staples completely.

Rather than imparting a pure linear strike parallel to the substrate, and perpendicular to the staple, the tool 10 also imparts tangential force (a vector) so as to lift the staple out of the substrate without destroying the staple or leaving the legs in the substrate. The lifting force is achieved by three means. First, the tool 10 is longitudinally cambered or curved along its bottom surface. As the air hammer imparts its strike to the tool 10, the camber rides the substrate resulting in a lift at blade 14 as the hammer strike extends/finishes. Second, the tool 10 has a beveled leading edge at teeth 15. The beveled edge will lift the staple as the crown rides up the bevel as the strike extends the tool 10 between the substrate and the fabric. This action is further aided by the transverse cambering or curvature of the underside 14′ of the blade 14. Thirdly, in some embodiments, the blade 14 is narrower at the distal-most end and then gets wider as it approaches the transition area 31. This more accurately applies to tools 50 and 90. This shape allows the blade 14 to splay out the staple legs in addition to lifting the crown of the staple resulting in an extremely efficient removal of covering and staples without the disadvantages of traditional tools and techniques. The tools 10, 50, and 90 will not do this as effectively without fabric between the staples and the substrate. Accordingly, in some embodiments the tools 10, 50, and 90 use the fabric to assist in the lifting of the staples.

It is also seen that in an alternative embodiment, the bottom and top surfaces of the blade end area are cambered upwardly, and the blade end converges in depth (or height), narrowing therein towards the blade teeth. This further provides for optimum interaction with the staples and legs as to allow for complementary sizes, geometries, configurations, and automatic engagement of blade, teeth, staple and legs.

Also note that the instant shank is cylindrical and designed using an industry standard for hammer chisels. Therefore, guns that fit these bits are readily accessible to end-users of the tool. In addition to keeping costs down, and giving more end users access to inventive bits, the shank rotates 360°. This rotation allows workers speed and ease of use as the angles necessary to access different areas of the staple removal work change. Also, the rotation keeps the gun handle and hose away from the work.

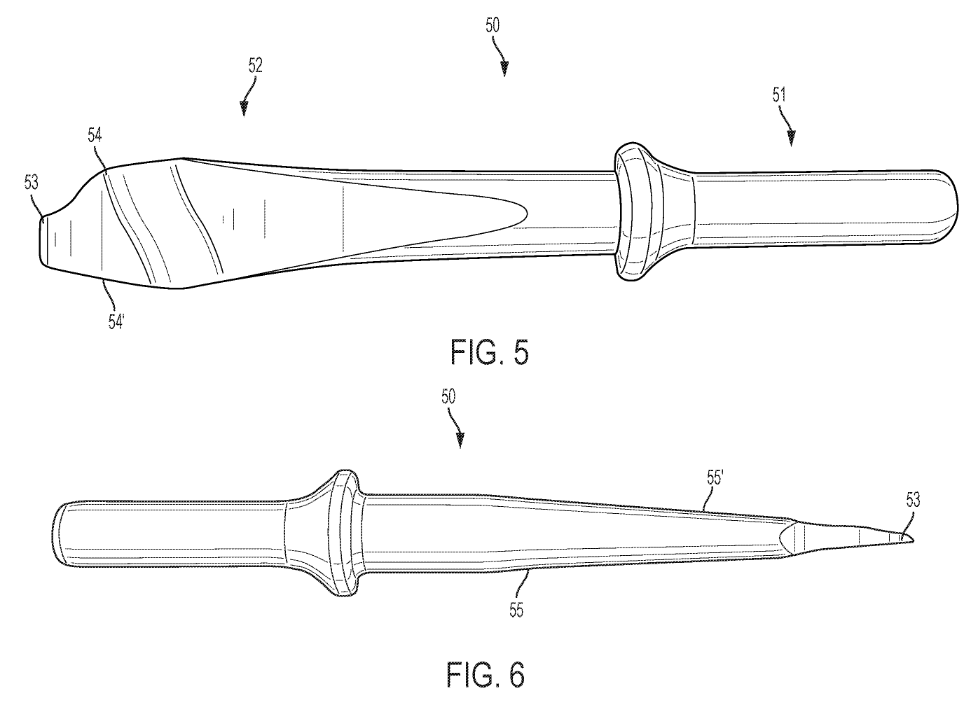

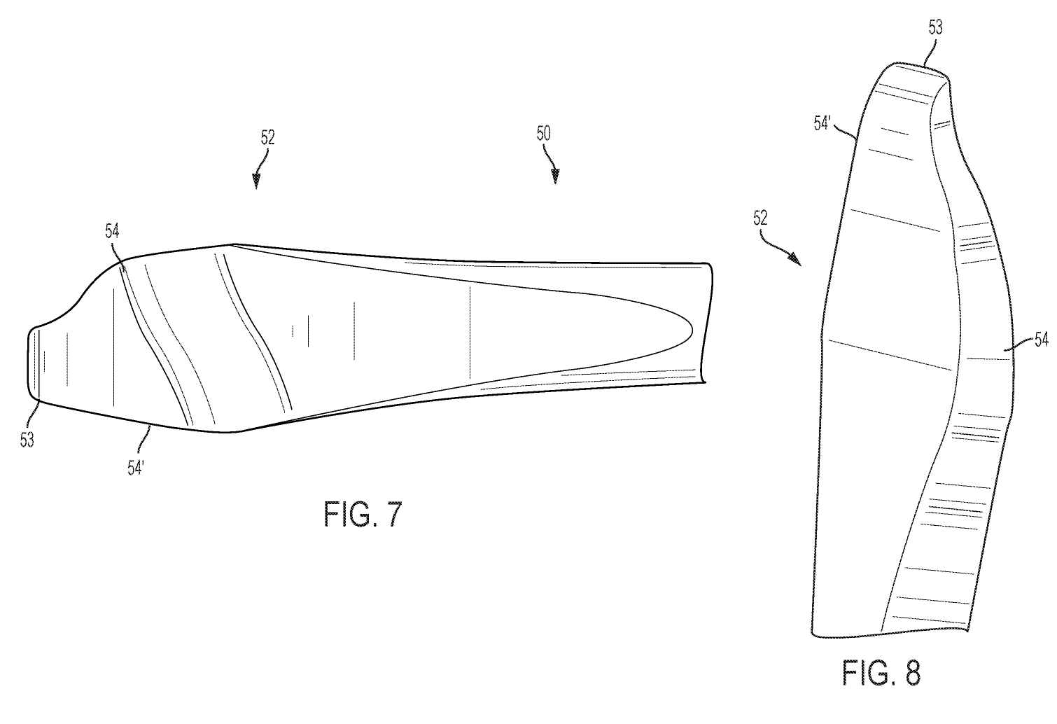

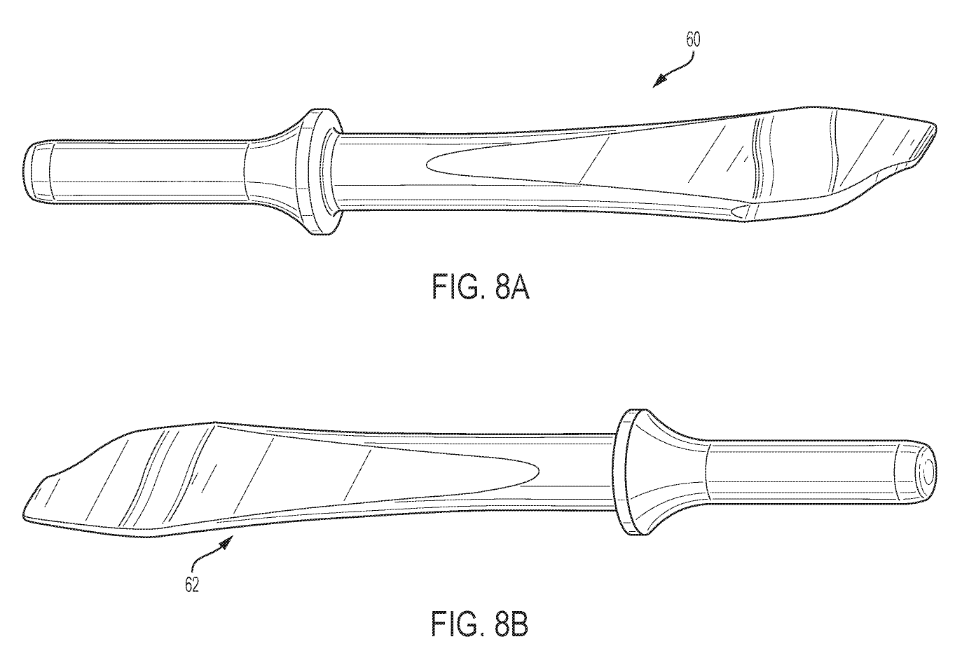

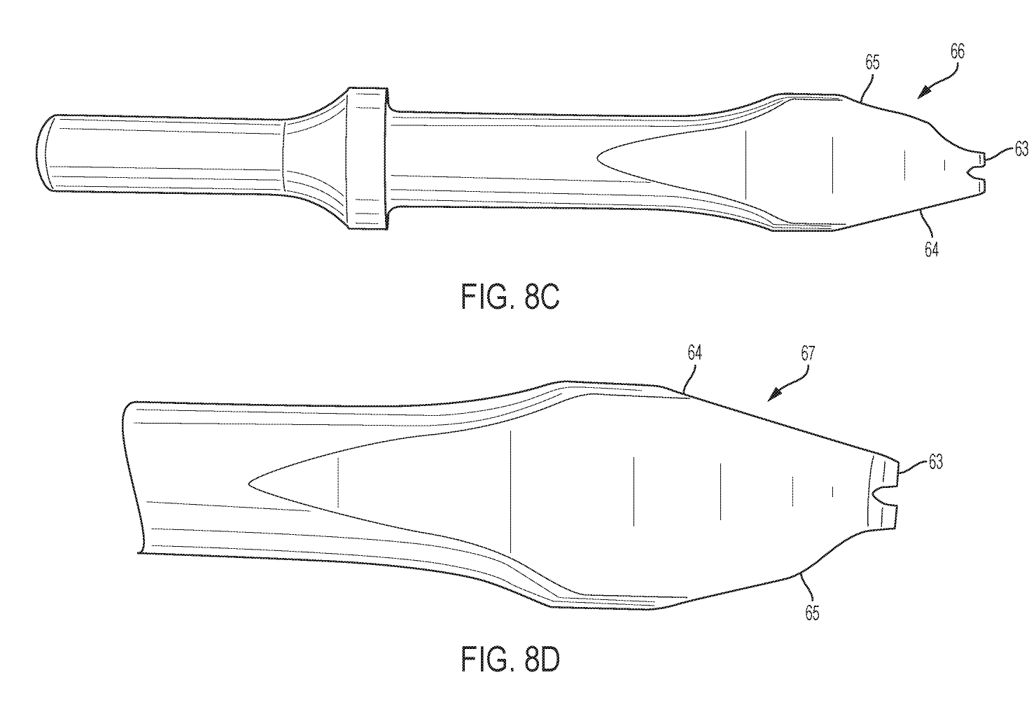

FIGS. 5-8 depict another embodiment of the present invention. Here, tool 50 comprises a proximal end 51 and a distal working end 52. The proximal end 51 may be configured as a shank that is received on an air gun, air chisel, or air hammer. The distal working end 52 comprises a chisel-like tip 53 that transitions into a curved side section 54 that flows back toward the proximal end 51 of the tool 50. With reference to FIG. 6, shown is a side perspective view of the tool 50. As illustrated, the bottom surface 55 of the tool is longitudinally angled, cambered, or curved upward in order to enhance the striking and removal action of the tool 50 when used as intended. This longitudinal cambering creates an angle between the tool 50 and the substrate during use, which creates a tangential application of force as opposed to a direct linear application of force. Tool 50 also has a cambered or angled top surface 55′, which is angled downwardly towards the working end and tip 53. Also evident in FIG. 6 is the geometry of the chisel tip 53, which has a beveled leading edge angled back toward the proximal end of the tool 50. In some embodiments, this angle is approximately 45 degrees but it may vary from between 20 and 70 degrees depending on the application and size of the tool 50. With reference to FIG. 7, shown is a close up of the working end 52 of the tool 50. Here, the chisel tip 53 and curved side section 54 can be more readily seen. The opposite side 54′ is straight and angled, such that this working end 52 has a non-symmetrical or asymmetrical shape for the purposes described herein. FIG. 8 shows a close up of the chisel tip 53 and curved side 54, more closely showing the beveling of the tip 53.

FIG. 8A is an alternative top perspective view of tool 60 as described in FIGS. 5-8.

FIG. 8B is an alternative bottom perspective view of tool 62 as described in FIGS. 5-8.

FIG. 8C is an alternative top view of another embodiment of tool 66, having curved and protruding side 65, along with opposite angled straight side 64, and teeth 63 of the chisel-like end.

FIG. 8D is an alternative expanded bottom view of another embodiment of tool 67, having curved and protruding side 65, along with opposite angled straight side 64, and teeth 63 of the chisel-like end.

FIG. 8E is an alternative top perspective view of the tool shown in FIG. 8C.

FIG. 8F is an alternative bottom perspective view of the tool shown in FIG. 8C.

FIG. 8G is an alternative expanded top view of the tool 68 shown in FIG. 8D.

This second embodiment of the tool carries the same general attributes of the first embodiments, with a cambered bottom surface used to provide a tangential application of force instead of only a linear application of force in combination with a beveled distal end that is designed to lift and separate fabric and staples from the underlying substrate. However, tool 50 as compared to tool 10 has a smaller working end by way of chisel tip 53 that is designed to be small enough to fit in between the staple legs so as to get underneath the staple crown. Because of its narrow design this tool 50 is better suited for removing one staple at a time or working in smaller or harder-to-reach areas. Additionally, the asymmetrical working end 52 and curved section 54 allows for a smoother application of force to the staples, having the effect of separating the legs of the staple without outright severing or snapping them off from the crown. This is a substantial advantage over prior art tools that may otherwise damage or destroy the staple, leaving the legs in the substrate.

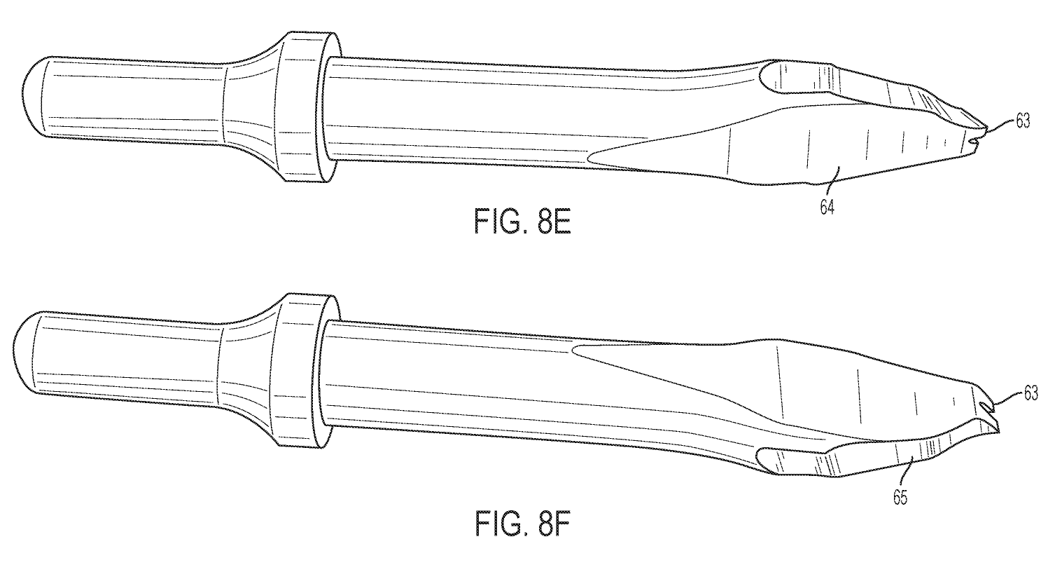

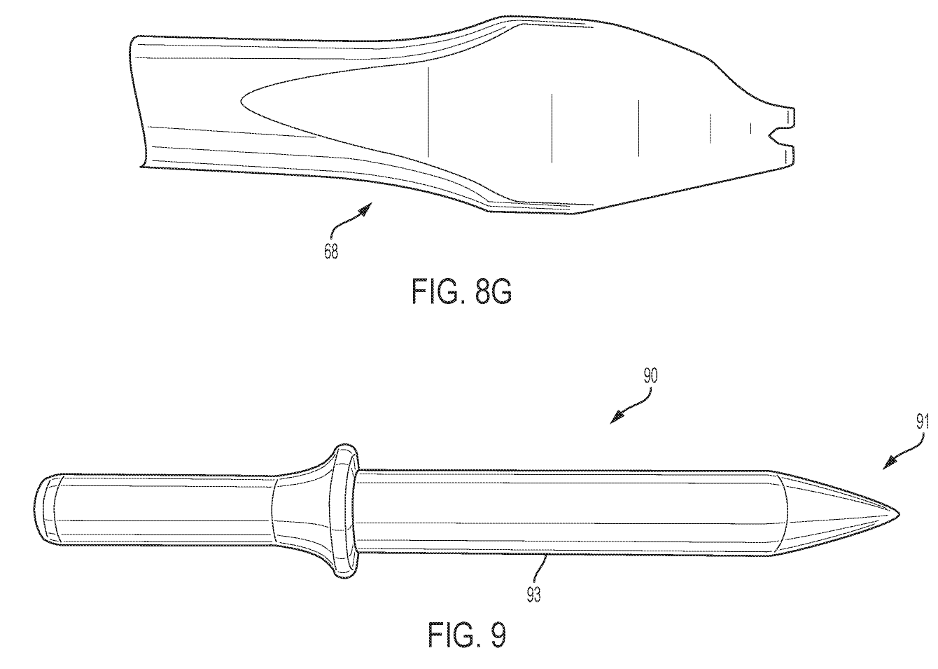

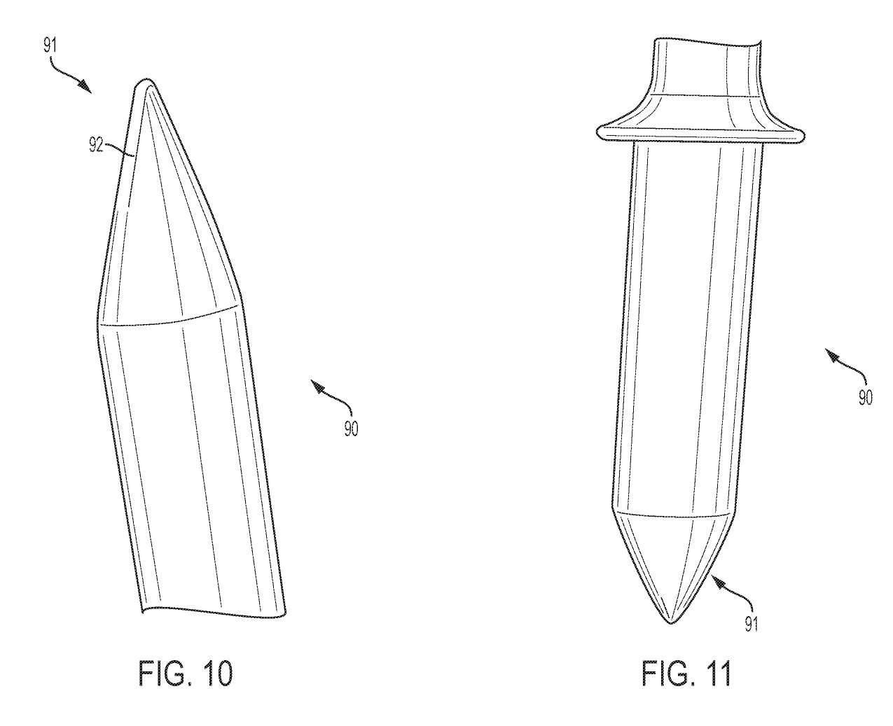

FIGS. 9-11 depict another embodiment of the tool, shown as tool 90 having generally the same features as the other embodiments except for a different distal tip design. Here, distal tip 91 is configured as an offset conical feature having circumferential cambering. In some embodiments, the top edge 92 is a flat edge as shown in FIG. 10, but in other embodiments the distal tip may be configured as a smooth cone as shown in FIG. 11. These embodiments carry the same general attributes as the other designs, with a cambered bottom surface 93 and a beveled tip end.

The present invention has several advantages over the prior art as previously outlined. In initial testing, the various embodiments of the tool have greatly reduced the time needed to remove stapled upholstery, reducing an hour-long job to just 2 to 3 minutes. Additionally, the job can be completed much more accurately, with no damage to the underlying substrate and with complete removal of the staples without leaving legs or pieces of staple in the substrate. It is further appreciated that while the tools are particularly useful in conjunction with pneumatic air chisels and air hammers, other powered devices such as electric hammers may also be compatible. The tools can also be adapted for manual applications, particularly useful for smaller jobs, although the working time will be increased.

While specific embodiments have been described in detail, those with ordinary skill in the art will appreciate that various modifications and alternatives to those details could be developed in light of the overall teachings of the disclosures. Accordingly, the particular arrangements disclosed are meant to be illustrative only and not limiting of the invention, which is to be given the full breadth of the appended claims, and any and all equivalents thereof.

What is claimed is:

1. A tool effective for removing staples or fasteners, comprising:
an elongated body having a proximal end and a distal working end;
said elongated body having a bottom surface;
said bottom surface of said elongated body being longitudinally cambered and curved upward from said proximal end toward said distal working end; and
said distal working end includes a beveled tip.

2. The tool of claim 1, wherein said distal working end comprises a blade having outer sides and a plurality of teeth.

3. The tool of claim 2, further comprising:
a curved transition area from said elongated body to said blade.

4. The tool of claim 2, wherein said plurality of teeth vary in width.

5. The tool of claim 2, wherein said outer sides of said blade are cambered.

6. The tool of claim 2, further comprising:
said blade having an underside; and
said underside of said blade is transversely cambered.

7. The tool of claim 1, wherein said distal working end comprises a chisel tip having an adjacent curved section.

8. The tool of claim 1, wherein said distal working end comprises a cambered offset conical tip.

9. The tool of claim 1, wherein said longitudinally cambered and curved bottom surface imparts a tangential application of force at said distal working end.

10. The tool of claim 1, wherein said proximal end comprises a shank adapted to fit a pneumatic hammer.

11. The tool of claim 1, wherein said beveled tip is beveled at an angle between 20 and 70 degrees toward the proximal end of said tool.

12. A tool effective for removing staples or fasteners, comprising:
an elongated body having a proximal end and a distal working end;
said elongated body having a bottom surface;
said bottom surface of said elongated body being longitudinally angled and upward from said proximal end toward said distal working end; and
said distal working end includes a beveled tip.

13. The tool of claim 12, further comprising:
said elongated body having a top surface; and
said top surface of said elongated body is longitudinally angled and downward from said proximal end toward said distal working end.

14. The tool of claim 13, further comprising:
said distal working end having two opposing sides;
a first opposing side be generally straight and angled toward said beveled tip; and
a second opposing side be curved inwardly toward said beveled tip.

15. The tool of claim 14, further comprising:
said beveled tip including a plurality of teeth.
